(19) United States
(12) Patent Application Publication
(10) Pub. No.: US 2015/0001876 A1
(43) Pub. Date: Jan. 1, 2015

(54) SECONDARY DASH AND METHODS OF MAKING AND USING THE SAME

(71) Applicant: GM Global Technology Operations LLC, Detroit, MI (US)

(72) Inventors: Robert N. Saje, Shelby Township, MI (US); Artur Wyszynski, Oxford, MI (US); Terry A. Swartzell, Ann Arbor, MI (US); Johnny Ristoski, Washington, MI (US)

(21) Appl. No.: 13/931,131

(22) Filed: Jun. 28, 2013

(51) Int. Cl. B62D 25/14

(52) U.S. Cl. CPC B62D 25/14
USPC 296/70; 228/101; 156/60; 29/428; 29/525.06

(57) ABSTRACT

A number of variations may include a product including a secondary dash including a center portion constructed and arranged to be attached to a primary dash of a vehicle.

### TECHNICAL FIELD

The field to which the disclosure generally relates to includes a secondary dash for a vehicle.

### BACKGROUND

Vehicles may be equipped with a dash in front of the passenger compartment.

### SUMMARY OF ILLUSTRATIVE VARIATIONS

A number of variations may include a product including a secondary dash including a center portion constructed and arranged to be attached to a primary dash of a vehicle.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a plan view illustrating a product including a primary dash and secondary dash according to a number of variations.

FIG. 2 is a close up of a front view of a product including a secondary dash according to a number of variations.

FIG. 3 is a sectional view illustrating the attachment of a portion of a center panel of a secondary dash to a layer of material utilizing an adhesive layer and a self-piercing rivet according to a number of variations.

FIG. 4 is a perspective view of a product including a primary dash and a secondary dash attached thereto according to a number of variations of the invention.

FIG. 5 is a schematic plan view of a 1-bar connected to a primary dash and a secondary dash according to a number of variation.

### DETAILED DESCRIPTION OF ILLUSTRATIVE VARIATIONS

The following description of the variations is merely illustrative in nature and is in no way intended to limit the scope of the invention, its application, or uses.

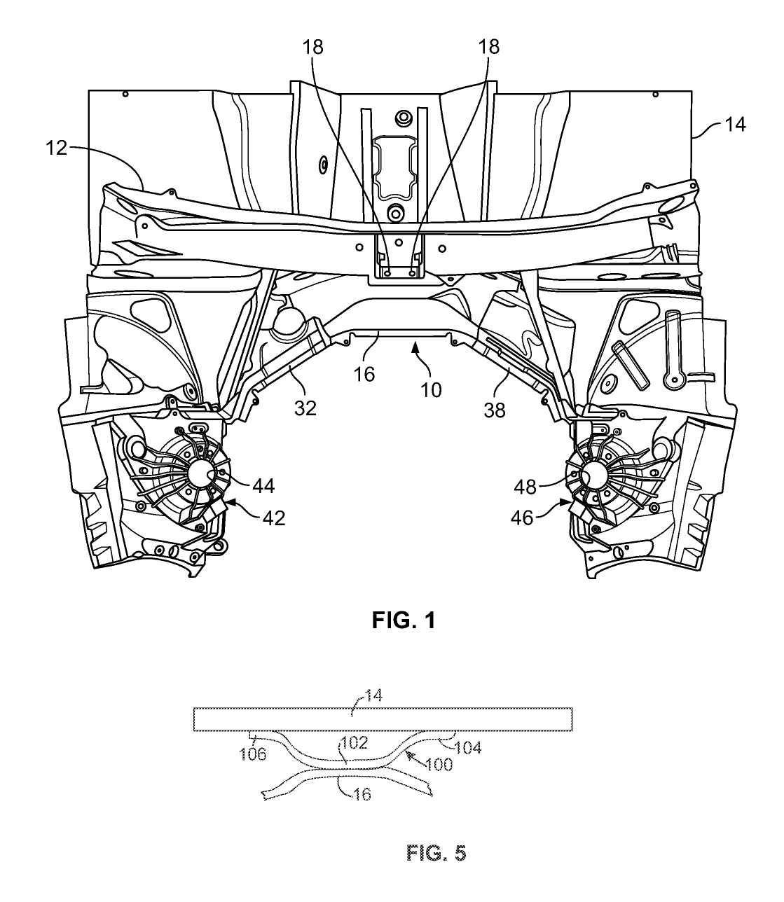

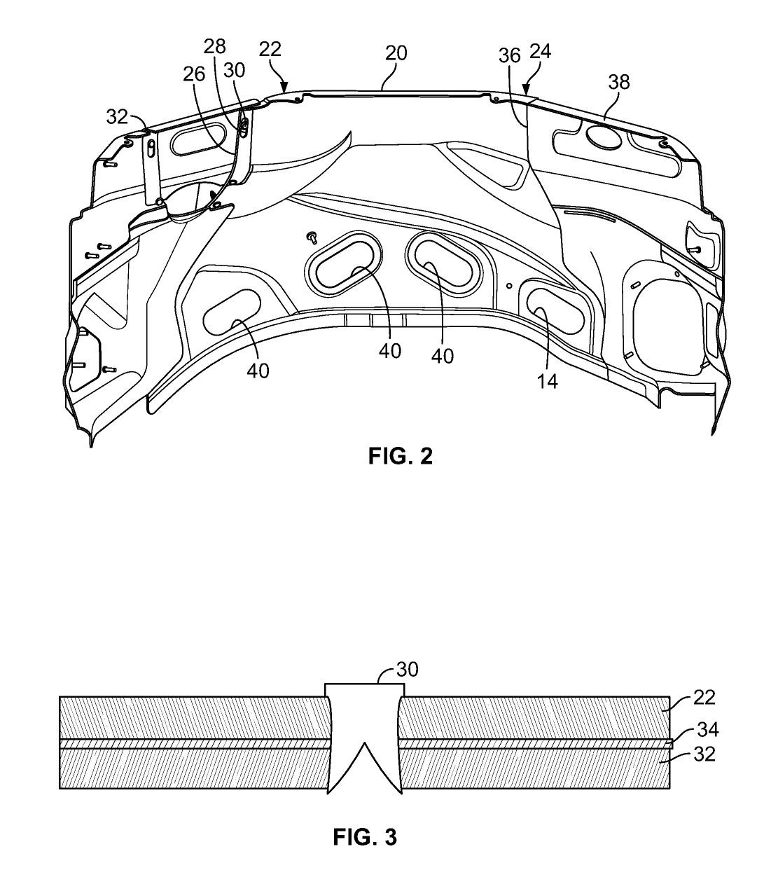

Referring now to FIGS. 1-3, a number of variations may include a product 10 which may include a secondary front dash 16 which may be attached to a vehicle primary front dash 12 which may be connected to or is a part of a vehicle underbody 14. The primary front dash 12 may be made from a variety of materials including, but not limited to, steel or aluminum alloys. The secondary dash 16 may be made from a material constructed and arranged to reduce the transfer of noise from the vehicle engine compartment into the vehicle passenger compartment above the underbody 14. In a number of variations, the secondary dash 16 may be made from a single material or a mixture of materials. In a number of variations, the secondary dash portion 16 may include a center panel 20 which may be composed of a steel material, for example steel having a density of 7.86 g/cm³ or greater. A first wing panel 32 may be connected to the center panel 20 along an edge 26 of a first outwardly angled portion 22. The first outwardly angled portion 22 may include a plurality of slots 28. The first wing panel 32 may be attached to the first outwardly angled portion 22 by an adhesive layer 34 and a self-piercing rivet 30 best seen in FIG. 3. The center panel 20 may include a second outwardly angled portion 24 and a second panel 38 may be attached to the second outwardly angled portion 24 using an adhesive layer and self-piercing rivet similarly to previously described with respect to the first outwardly angled portion 22.

The center panel 20 may include a plurality of access openings 40 formed there through to provide access to the primary dash 12 so that the center panel 20 may be attached thereto directly or indirectly by any of a variety of methods including welding. In a number of variations the first wing panel 32 and second wing panel 38 may be made from an aluminum alloy which may be stamped. The first wing panel 32 may include a portion 42 constructed and arranged to provide structural connection to a shock tower, on a first side of the vehicle, including a through hole 44. The second wing panel 38 may be similarly constructed and may include a second portion 46 constructed and arranged to provide structural connection to a shock tower, on a first side of the vehicle, including a through hole 48 formed therein.

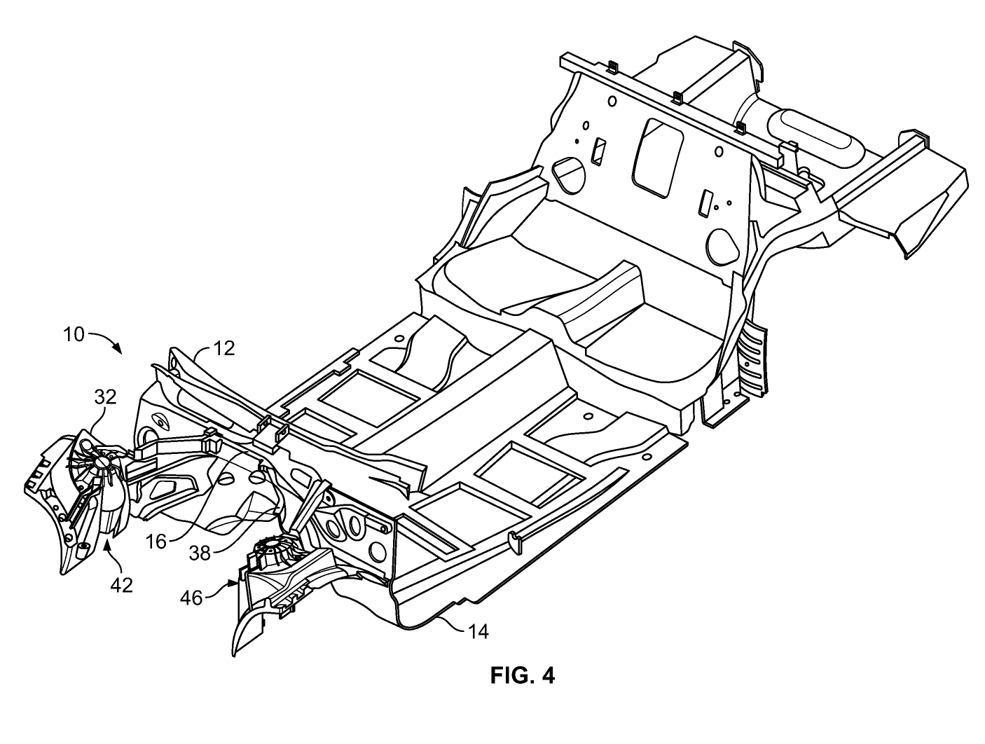

Referring now to FIGS. 4-5, a product 10 according to a number of variations of the invention may include a secondary dash 16 which may include a center panel 20 having a first wing panel 32 extending from a first edge thereof and a second wing panel 38 extending from a second edge thereof. The secondary dash 16 may be attached to a #1 bar assembly 100 which may be attached to the primary dash 12 of the vehicle underbody 14. in a number of variations the 1-bar 100 may include a center portion 102 which may be attached to the secondary dash 16 by welding or other means of fastening. The 1-bar mar have a second portion 104 which may be an end portion and an opposite third portion 106 which may be an end portion. Each of the second portion 104 and third portion 106 may be attached to the primary dash 12 by welding or other means of fastening. In one variation the 1 bar 100 may first be attached to the secondary dash 16 and thereafter the 1-bar 100 may be attached to the primary dash 12. Access openings 40 in the secondary dah 16 may be constructed and arranged to allow welding equipment to extend there through to weld the 1-bar 100 to the primary dash 12.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: a secondary dash for a vehicle, the secondary dash including a center panel having a center portion constructed and arranged to be attached to a primary dash of a vehicle and a first outwardly angled portion constructed and arranged to be displaced a distance from the primary dash and a second opposite outwardly angled portion extending from the center portion and constructed and arranged to be displaced a distance from the primary dash of a vehicle.

Variation 2 may include a product as set forth in Variation 1 wherein the secondary dash further comprises a first wing panel attached to the first outwardly angled portion and a second wing panel attached to the second outwardly angled portion.

Variation 3 may include a product as set forth in Variation 2 wherein the center panel comprises a first material, and wherein the first wing panel and the second wing panel each comprise a second material, and wherein the first material and the second material are different.

Variation 4 may include a product as set forth in any of

Variations 2-4 wherein the center panel comprises steel and wherein each of the first wing panel and second wing panel comprises an aluminum alloy.

Variation 5 may include a product as set forth in any of

Variations 1-4 wherein the center panel comprises steel.

Variation 6 may include a product as set forth in Variation 5 wherein the steel has a density of 7.86 g/cm3 or greater.

Variation 7 may include a product as set forth in any of

Variations 2-6 wherein the first wing panel is constructed and arranged to define a first portion for structural connection to a shock tower on a first side of the vehicle and wherein the second panel is constructed and arranged to define a structural connection to a shock tower on a second side of the vehicle.

Variation 8 may include a product as set forth in any of

Variations 2-7 wherein the first wing panel and second wing panel are each attached to the center panel by a plurality of self-piercing rivets.

Variation 9 may include a product as set forth in any of

Variations 2-9 further comprising a first adhesive layer interposed between overlapping portions of the first wing panel and the center panel, and a second adhesive layer interposed between overlapping portions of the second wing panel and the center panel.

Variation 10 may include a product as set forth in any of

Variations 1-9 wherein the center panel includes a plurality of access openings formed therein constructed and arranged to allow welding equipment to be inserted through each of the access openings.

Variation 11 may include a product as set forth in any of

Variations 1-10 further comprising a primary dash of a vehicle and wherein the secondary dash is attached to a #1 bar assembly which is attached to the primary dash.

Variation 12 may include a product as set forth in any of

Variations 1-10 further comprising a primary dash and wherein the center panel is welded to a 1-bar which is welded to the primary dash.

Variation 13 may include a product as set forth in Variation 12 wherein each of the primary dash and secondary dash comprise steel.

Variation 14 may include a product as set forth in any of

Variations 1-13 wherein the secondary dash further comprises a first wing panel attached to the first outwardly angled portion and a second wing panel attached to the second outwardly angled portion.

Variation 15 may include a product as set forth in any of

Variations 2-14 wherein each of the first wing panel and second wing panel each comprise an aluminum alloy.

Variation 16 may include a method comprising: forming a secondary dash for a vehicle comprising providing a center panel having a center portion and a first outwardly angled portion and a second opposite outwardly angled portion, attaching a first wing panel to the first outwardly angled portion, and attaching a second wing panel to the second outwardly angled portion, and attaching the secondary dash to a primary dash of the vehicle.

Variation 17 may include a method as set forth in Variation 16 further comprising attaching the secondary dash to a #1 bar assembly which is attached to the primary dash for the vehicle.

Variation 18 may include a method as set forth in Variation 17 wherein the attaching the secondary dash to a 1-bar assembly comprises welding the secondary dash to the 1-bar and then welding the 1-bar to the primary dash.

Variation 19 may include a method as set forth in Variation 17 wherein the attaching a first wing panel to the first outwardly angled portion comprises adhering the first wing panel to the first outwardly angled portion by interposing an adhesive layer there between.

Variation 20 may include a method as set forth in Variation 17 wherein the attaching a first wing panel to the first outwardly angled portion comprises inserting a plurality of self-piercing rivets through or into the a first wing panel and the first outwardly angled portion.

The above description of select variations within the scope of the invention is merely illustrative in nature and, thus, variations or variants thereof are not to be regarded as a departure from the spirit and scope of the invention.

What is claimed is:

1. A product comprising:
a secondary dash for a vehicle, the secondary dash including a center panel having a center portion constructed and arranged to be attached to a 1 bar or a primary dash of a vehicle and a first outwardly angled portion constructed and arranged to be displaced a distance from the primary dash and a second opposite outwardly angled portion extending from the center portion and constructed and arranged to be displaced a distance from the primary dash of a vehicle.

2. A product as set forth in claim 1 wherein the secondary dash further comprises a first wing panel attached to the first outwardly angled portion and a second wing panel attached to the second outwardly angled portion.

3. A product as set forth in claim 2 wherein the center panel comprises a first material, and wherein the first wing panel and the second wing panel each comprise a second material, and wherein the first material and the second material are different.

4. A product as set forth in claim 2 wherein the center panel comprises steel and wherein each of the first wing panel and second wing panel comprises an aluminum alloy.

5. A product as set forth in claim 4 wherein the center panel comprises steel.

6. A product as set forth in claim 5 wherein the steel has a density of 7.86 g/cm³ or greater.

7. A product as set forth in claim 2 wherein the first wing panel is constructed and arranged to define a first portion for structural connection to a shock tower on a first side of the vehicle and wherein the second panel is constructed and arranged to define a structural connection to a shock tower on a second side of the vehicle.

8. A product as set forth in claim 2 wherein the first wing panel and second wing panel are each attached to the center panel by a plurality of self-piercing rivets.

9. A product as set forth in claim 8 further comprising a first adhesive layer interposed between overlapping portions of the first wing panel and the center panel, and a second adhesive layer interposed between overlapping portions of the second wing panel and the center panel.

10. A product as set forth in claim 1 wherein the center panel includes a plurality of access openings formed therein constructed and arranged to allow welding equipment to be inserted through each of the access openings.

11. A product as set forth in claim 1 further comprising a primary dash of a vehicle and wherein the secondary dash is attached directly or indirectly to the primary dash.

12. A product as set forth in claim 10 further comprising a primary dash and wherein the center panel is welded to the primary dash.

13. A product as set forth in claim 12 wherein each of the primary dash and secondary dash comprise steel.

14. A product as set forth in claim 13 wherein the secondary dash further comprises a first wing panel attached to the first outwardly angled portion and a second wing panel attached to the second outwardly angled portion.

15. A product as set forth in claim 14 wherein each of the first wing panel and second wing panel each comprise an aluminum alloy.

16. A method comprising:
forming a secondary dash for a vehicle comprising providing a center panel having a center portion and a first outwardly angled portion and a second opposite outwardly angled portion, attaching a first wing panel to the first outwardly angled portion, and attaching a second wing panel to the second outwardly angled portion, and attaching the secondary dash to a primary dash of the vehicle.

17. A method as set forth in claim 16 further comprising attaching the secondary dash to a primary dash for the vehicle.

18. A method as set forth in claim 17 wherein the attaching the secondary dash to a primary dash for the vehicle comprises welding the secondary dash to a 1-bar and welding the 1-bar to the primary dash.

19. A method as set forth in claim 17 wherein the attaching a first wing panel to the first outwardly angled portion comprises adhering the first wing panel to the first outwardly angled portion by interposing an adhesive layer there between.

20. A method as set forth in claim 17 wherein the attaching a first wing panel to the first outwardly angled portion comprises inserting a plurality of self-piercing rivets through or into the a first wing panel and the first outwardly angled portion.
